(19) United States
(12) Patent Application Publication
(10) Pub. No.: US 2017/0280494 A1
(43) Pub. Date: Sep. 28, 2017

(54) METHOD FOR PROVIDING VIDEO CALL AND ELECTRONIC DEVICE THEREFOR

(71) Applicant: Samsung Electronics Co., Ltd., Gyeonggi-do (KR)

(72) Inventors: Eui-Chang JUNG, Seoul (KR); Su-Ha YOON, Seoul (KR)

(73) Assignee: Samsung Electronics Co., Ltd.

(21) Appl. No.: 15/416,515

(22) Filed: Jan. 26, 2017

(30) Foreign Application Priority Data
Mar. 23, 2016 (KR) 10-2016-0034901

(51) Int. Cl. H04W 76/02; H04N 7/14; H04N 7/15; H04M 1/725

(52) U.S. Cl. CPC H04W 76/026; H04M 1/72583; H04N 7/147; H04N 7/15; H04M 2201/50; H04W 88/06

(57) ABSTRACT

An electronic device is provided which includes a communication interface configured to support a plurality of communication schemes, and a processor configured to receive, through the communication interface, a request message for a video call between the electronic device and a first external electronic device from a second external electronic device, select a first wireless communication scheme to be used for a communication connection for the video call from among the plurality of communication schemes, identify connection information allocated to the electronic device by a third external electronic device connected to the electronic device, using the first wireless communication scheme, and control the communication interface to transmit, to the second external electronic device, a response message in response to the request message such that at least part of the connection information is used for establishing the communication connection.

### PRIORITY

This application claims priority under 35 U.S.C. §119(a) to Korean Patent Application Serial No. 10-2016-0034901, which was filed in the Korean Intellectual Property Office on Mar. 23, 2016, the entire content of which is incorporated herein by reference.

### BACKGROUND

1. Field of the Disclosure

The present disclosure generally relates to an electronic device, and more particularly, to a method in an electronic device for converting a voice call between users into a video call.

2. Description of the Related Art

Due to the development of information communication technologies and semiconductor technologies, the supply and use of various portable terminals has rapidly increased. Mobile communication terminals provide various functions, such as a TV viewing function (e.g., digital multimedia broadcasting (DMB) or digital video broadcasting (DVB)), a music reproduction function (e.g., MPEG audio layer-3 (MP3)), a photography function, and an Internet access function, in addition to a communication function, such as a voice call or message transmission/reception.

A video call function is a method of sharing voice and images between users. However, it is difficult to convert a voice call into a video call and vice versa, even for an electronic device containing a video call function. A user may determine whether to execute only a voice call function or only a video call function at the beginning of the call, and may be provided with only the selected call service for the duration of the call.

### SUMMARY

According to an aspect of the present disclosure, a method is provided for converting a voice call to a video call in an electronic device. According to another aspect of the present disclosure, an electronic device is provided which includes a communication interface configured to support a plurality of communication schemes, and a processor configured to receive, through the communication interface, a request message for a video call between the electronic device and a first external electronic device from a second external electronic device, select a first wireless communication scheme to be used for a communication connection for the video call from among the plurality of communication schemes, identify connection information allocated to the electronic device by a third external electronic device connected to the electronic device, using the first wireless communication scheme, and control the communication interface to transmit, to the second external electronic device, a response message in response to the request message such that at least part of the connection information is used for establishing the communication connection.

In accordance with another aspect of the present disclosure, a method for providing a video call by an electronic device is provided. The method includes receiving, from a second external electronic device, a request message for a video call between the electronic device and a first external electronic device, through a first communication module, selecting a first communication scheme to be used for a communication connection for the video call from among the plurality of communication schemes, identifying connection information allocated to the electronic device by a third external electronic device connected to the electronic device in communication, using the first communication scheme, and transmitting, to the second external electronic device, a response message in response to the request message such that at least part of the connection information is used for establishing the communication connection.

In accordance with another aspect of the present disclosure, an electronic device is provided which includes at least one communication interface configured to support a plurality of communication schemes, and a processor, wherein the processor is configured to transmit, through the at least one communication interface, a request message for a second communication connection for a video call with a first external electronic device to a second external electronic device, in a state in which a first communication connection for a voice call between the electronic device and the first external electronic device is established using a first wireless communication scheme through the at least one communication interface, and if a response message in response to the request message is received from the second external electronic device, control the at least one communication interface to establish the second communication connection based on the response message.

In accordance with another aspect of the present disclosure, a non-transitory storage medium storing instructions is provided in which the instructions, when executed by at least one processor, cause the processor to execute a method including receiving, from a second external electronic device, a request message for a video call between the electronic device and a first external electronic device, through a first communication module, selecting a first communication scheme to be used for a communication connection for the video call from among the plurality of communication schemes, identifying connection information allocated to the electronic device by a third external electronic device connected to the electronic device in communication, using the first communication scheme, and transmitting, to the second external electronic device, a response message in response to the request message such that at least part of the connection information is used for establishing the communication connection.

### BRIEF DESCRIPTION OF THE DRAWINGS

The above and other aspects, features, and advantages of the present disclosure will be more apparent from the following detailed description when taken in conjunction with the accompanying drawings, in which:

FIG. 1 is a diagram illustrating a network environment including an electronic device, according to an embodiment of the present disclosure;

FIG. 2 is a block diagram of an electronic device, according to an embodiment of the present disclosure;

FIG. 3 is a block diagram of a program module, according to an embodiment of the present disclosure;

FIG. 4 is a diagram illustrating a connection between electronic devices, according to an embodiment of the present disclosure;

FIG. 5 is a diagram illustrating a connection between electronic devices, according to another embodiment of the present disclosure;

FIG. 6 is a flowchart of a method in which an electronic device converts a voice call into a video call, according to an embodiment of the present disclosure;

FIG. 7 is a flowchart of a method in which an electronic device converts a voice call into a video call, according to another embodiment of the present disclosure;

FIG. 8 is a flowchart of a method in which an electronic device converts a voice call into a video call, according to another embodiment of the present disclosure;

FIG. 9 is a flowchart of a method in which an electronic device converts a voice call into a video call, according to another embodiment of the present disclosure;

FIG. 10 is a flowchart of a method in which an electronic device converts a voice call into a video call, according to another embodiment of the present disclosure;

FIG. 11 is a flowchart of a method in which an electronic device converts a voice call into a video call, according to another embodiment of the present disclosure;

FIG. 12 is a flow diagram of a method in which electronic devices establish a video call, according to an embodiment of the present disclosure;

FIG. 13 is a flow diagram of a method in which electronic devices establish a video call, according to another embodiment of the present disclosure;

FIG. 14 is a flow diagram of a method in which electronic devices establish a video call, according to another embodiment of the present disclosure; and

FIGS. 15A to 15C are execution screens illustrating a method in which an electronic device converts a voice call into a video call, according to an embodiment of the present disclosure.

### DETAILED DESCRIPTION

Hereinafter, an embodiment of the present disclosure will be described with reference to the accompanying drawings. However, it should be understood that there is no limiting the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expressions “have”, “may have”, “include”, or “may include” refer to the existence of a corresponding feature (e.g., numeral, function, operation, or constituent element such as component), and do not exclude one or more additional features.

Throughout the specification, the expressions “A or B”, “at least one of A or/and B”, “one or more of A or/and B” and the like may include all combinations of the listed items. For example, the expressions “A or B”, “at least one of A and B”, or “at least one of A or B” refer to all of (1) including at least one A, (2) including at least one B, or (3) including all of at least one A and at least one B.

The expressions “a first”, “a second”, “the first”, or “the second” as used in embodiments of the present disclosure may modify various components regardless of the order and/or the importance but do not limit the corresponding components. For example, a first user device and a second user device may indicate different user devices although both of them are user devices. For example, a first element may be referred to as a second element, and similarly, a second element may be referred to as a first element without departing from the scope of the present disclosure.

When it is mentioned that one element (e.g., a first element) is operatively or communicatively coupled with/to or connected to another element (e.g., a second element), it should be construed that the one element is directly connected to the other element or the one element is indirectly connected to the other element via yet another element (e.g., a third element). Conversely, when one component element is “directly coupled” or “directly connected” to another component element, it may be construed that a third component element does not exist between the first component element and the second component element.

The expression “configured (or set) to”, as used in this specification, may be interchangeably used with, for example, “suitable for”, “having the capacity to”, “designed to”, “adapted to”, “made to”, or “capable of” according to circumstances. The term “configured to” may not necessarily imply “specifically designed to” in hardware. Instead, in some cases, the expression “device configured to” may mean that the device may together with other devices or components. For example, the phrase “processor adapted (or configured) to perform A, B, and C” may mean a dedicated processor (e.g., embedded processor) only for performing the corresponding operations or a general-purpose processor (e.g., central processing unit (CPU) or application processor (AP)) that may perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Terms such as those defined in a generally used dictionary may be interpreted to have the same meanings as the contextual meanings in the relevant field of art, and are not to be interpreted to have ideal or excessively formal meanings unless clearly defined in the present disclosure. In some cases, even the terms defined in the present disclosure should not be interpreted to exclude embodiments of the present disclosure.

An electronic device, according to an embodiment of the present disclosure, may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device. The wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to an embodiment of the present disclosure, the electronic device may be a home appliance. The home appliance may include at least one of, for example, a television, a digital video disk (DVD) player, an audio player, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to an embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment device, an electronic device for a ship (e.g., a navigation device for a ship, and a gyro-compass), avionics, security devices, an automotive head unit, a robot for home or industry, an automatic teller machine (ATM), point of sales (POS) terminal, or an Internet of things (IoT) device (e.g., a light bulb, various sensors, electric or gas meter, a sprinkler device, a fire alarm, a thermostat, a streetlamp, a toaster, a sporting good, a hot water tank, a heater, a boiler, etc.).

According to an embodiment of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device may be a combination of one or more of the aforementioned various devices. The electronic device may also be a flexible device. Further, the electronic device is not limited to the aforementioned devices, and may include a new electronic device according to the development of new technology.

Hereinafter, an electronic device according to an embodiment of the present disclosure will be described with reference to the accompanying drawings. In the present disclosure, the term “user” may indicate a person using an electronic device or a device (e.g., an artificial intelligence electronic device) using an electronic device.

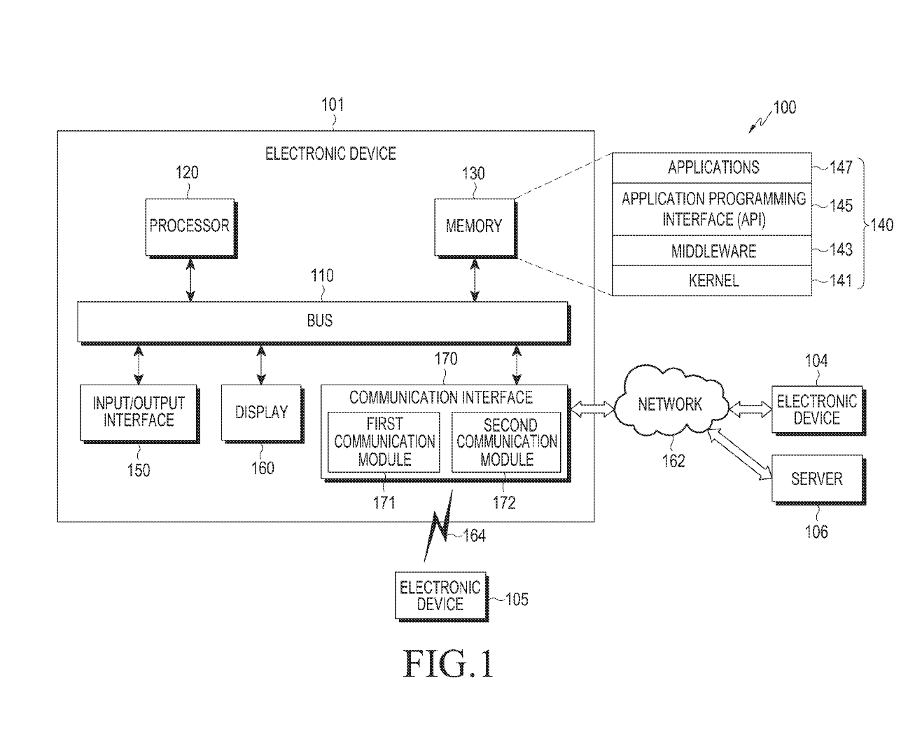

FIG. 1 is a diagram illustrating a network environment including an electronic device, according to an embodiment of the present disclosure.

A first electronic device 101 within a network environment 100, will be described with reference to FIG. 1.

The first electronic device 101 includes a bus 110, a processor 120, a memory 130, an input/output interface 150, a display 160, and at least one communication interface 170. The first electronic device 101 may omit at least one of the elements, or may further include other elements.

The bus 110 includes, for example, a circuit for connecting the elements 120 to 170 and transferring communication (e.g., control messages and/or data) between the elements.

The processor 120 may include one or more of a central processing unit (CPU), an application processor (AP), and a communication processor (CP). For example, the processor 120 may carry out operations or data processing relating to the control and/or communication of at least one other element of the first electronic device 101.

The processor 120 may control the first electronic device 101 to execute a voice call or a video call. According to an embodiment of the present disclosure, the processor 120 may execute a voice call with one or more electronic devices using a first communication module 171 (e.g., a cellular communication module). Hereinafter, it is assumed that a partner electronic device that executes a voice call or a video call with the first electronic device 101 is a second electronic device 104.

According to an embodiment of the present disclosure, the processor 120 may execute a voice call through an application associated with the voice call from among applications stored in advance in the memory 130. For example, a user of the first electronic device 101 selects and executes an application for a voice call, to enable the first electronic device 101 to execute a voice call operation.

According to an embodiment of the present disclosure, the processor 120 may execute a video call using the first communication module 171 or a second communication module 172 (e.g., a WiFi module). A video call may be executed through an application associated with the video call from among applications stored in advance in the memory 130. For example, when a user of the first electronic device 101 selects and executes an application for a video call, the first electronic device 101 executes a video call operation.

When the user of the first electronic device 101 desires to execute a voice call, the processor 120 sends a call associated with a voice call to a partner electronic device (e.g., the second electronic device 104) according to a user input (e.g., a touch input, a voice input, a fingerprint input, a gesture input, and the like) for executing the voice call. Also, when a call for a voice call is received from the partner electronic device (e.g., the second electronic device 104), the electronic device may proceed with a voice call with the partner electronic device (e.g., the second electronic device 104) according to a user input (e.g., a touch input, a voice input, a fingerprint input, a gesture input, and the like) for executing the voice call. When the first electronic device 101 and the second electronic device 104 execute a voice call, a communication channel (hereinafter, a first channel) for transmitting and receiving audio (that is, voice data) may be formed between the first electronic device 101 and the second electronic device 104.

In the same manner, when the user of the first electronic device 101 desires to execute a video call, the processor 120 sends a request for a video call to a partner electronic device (e.g., the second electronic device 104) according to a user input (e.g., a touch input, a voice input, a fingerprint input, a gesture input, and the like) for executing the video call. When a request for a video call is received from the partner electronic device (e.g., the second electronic device 104), the electronic device may proceed with a video call with the partner (second) electronic device according to a user input (e.g., a touch input, a voice input, a fingerprint input, a gesture input, and the like) for executing the video call. When the first electronic device 101 and the second electronic device 104 execute a video call, a separate communication channel (hereinafter, a second channel) for transmitting and receiving an image may be formed between the first electronic device 101 and the second electronic device 104, in addition to the communication channel for transmitting and receiving audio (voice data).

According to an embodiment of the present disclosure, the processor 120 may combine audio received from the second electronic device 104 through the first channel and an image received from the second electronic device 104 through the second channel. The processor 120 may synchronize the audio and the image (in real time), and may control the first electronic device 101 to output the synchronized data.

According to an embodiment of the present disclosure, for example, when the first electronic device 101 and the second electronic device 104 desire to convert to a video call during a voice call, an invite message for the video call may be generated. The processor 120 may transmit, to the second electronic device 104, the invite message through the first communication interface 171. According to the invite message from the first electronic device 101, the second electronic device 104 may inform a user of the second electronic device 104 that a video call is executable between the first electronic device 101 and the second electronic device 104. For example, when it is assumed that the user of the first electronic device 101 is Kate, a display of the second electronic device 104 displays the phrase “you've got a video call request from Kate”. Therefore, the user of the second electronic device 104 may be informed that a video call request is received from the first electronic device 101.

The memory 130 may include a volatile and/or non-volatile memory. The memory 130 may store, for example, instructions or data relating to at least one other element of the first electronic device 101. According to an embodiment of the present disclosure, the memory 130 stores software and/or a program 140. The program 140 includes, for example, a kernel 141, middleware 143, an application programming interface (API) 145, and/or application programs (or “applications”) 147. At least some of the kernel 141, the middleware 143, and the API 145 may be referred to as an operating system (OS).

According to an embodiment of the present disclosure, a first application for a voice call or a second application for a video call may be stored in the memory 130.

The kernel 141 may control or manage system resources (e.g., the bus 110, the processor 120, or the memory 130) used for executing an operation or function implemented in other programs (e.g., the middleware 143, the API 145, or the application 147). Furthermore, the kernel 141 may provide an interface through which the middleware 143, the API 145, or the application programs 147 may access the individual elements of the first electronic device 101 to control or manage the system resources.

The middleware 143 may function as, for example, an intermediary for allowing the API 145 or the application programs 147 to communicate with the kernel 141 to exchange data.

Furthermore, the middleware 143 may process one or more task requests, which are received from the application programs 147, according to priorities thereof. For example, the middleware 143 may assign priorities for using the system resources (e.g., the bus 110, the processor 120, the memory 130, etc.) of the first electronic device 101 to at least one of the application programs 147. For example, the middleware 143 may perform scheduling or loading balancing on the one or more task requests by processing the one or more task requests according to the priorities assigned to the one or more application programs.

The API 145, which is an interface through which the applications 147 control functions provided from the kernel 141 or the middleware 143, may include, for example, at least one interface or function (e.g., instruction) for file control, window control, image processing, text control, and the like.

The input/output interface 150 may function as, for example, an interface that may transfer instructions or data input from a user or another external device to the other element(s) of the first electronic device 101. In addition, the input/output interface 150 may output instructions or data received from the other element(s) of the first electronic device 101 to the user or other external devices.

The display 160 may include, for example, a liquid crystal display (LCD), a light emitting diode (LED) display, an organic light emitting diode (OLED) display, a micro electro mechanical system (MEMS) display, or an electronic paper display. The display 160 may display, for example, various types of content (e.g., text, images, videos, icons, or symbols) to the user. The display 160 may include a touch screen and may receive, for example, a touch input, a gesture input, a proximity input, or a hovering input using an electronic pen or a part of the user's body.

The communication interface 170 may set communication, for example, between the first electronic device 101 and the second external electronic device 104, a third external electronic device 105 or a server 106. For example, the communication interface 170 may be connected to a network 162 through wireless or wired communication to communicate with the second external electronic device 104 or the server 106.

According to an embodiment of the present disclosure, the communication interface 170 includes the first communication module 171 and the second communication module 172. The first communication module 171 may perform cellular communication. The first electronic device 101 may perform a voice call using the first communication module 171. The first electronic device 101 may transmit/receive, to/from the second electronic device 104 or the third electronic device 105, audio that is generated during a voice call with the other electronic device through the first communication module 171.

The first electronic device 101 may perform a video call using the second communication module 172. The first electronic device 101 may execute WiFi communication through the second communication module 172. The first electronic device 101 may transmit/receive, to/from the second electronic device 104 or the third electronic device 105, an image (e.g., a still image, a moving image) that is generated during a video call with the other electronic device through the second communication module 172.

According to an embodiment of the present disclosure, when the first electronic device 101 is requested to convert to a video call during a voice call using the first communication module 171, the processor 120 of the first electronic device 101 may execute the second communication module 172. The processor 120 may transmit, to the second electronic device 104, an image (e.g., a still image, a moving image) that is stored in advance in the memory 130 or an image that is captured in real time, through the second communication module 172. Also, the processor 120 may receive, an image (e.g., a still image, a moving image) transmitted from the partner electronic device, through the second communication module 172. As described above, the first electronic device 101 may transmit and receive a voice that is audio, an image excluding the audio, through different communication modules, respectively, when a video call is executed. The first communication module 171 may transmit and receive both audio and an image through cellular communication.

The wireless communication may use at least one of, for example, long term evolution (LTE), LTE-advance (LTE-A), code division multiple access (CDMA), wideband CDMA (WCDMA), universal mobile telecommunications system (UMTS), wireless broadband (WiBro), and global system for mobile communications (GSM), as a cellular communication protocol. Furthermore, the wireless communication may include, for example, short range communication 164. The short range communication 164 may include, for example, at least one of WiFi, Bluetooth, near field communication (NFC), global navigation satellite system (GNSS), and the like. The GNSS may include at least one of, for example, a global positioning system (GPS), a global navigation satellite system (Glonass), a Beidou navigation satellite system (Beidou), and Galileo (European global satellite-based navigation system). Hereinafter, in the present disclosure, the term “GPS” may be interchangeably used with the term “GNSS”. The wired communication may include, for example, at least one of a universal serial bus (USB), a high definition multimedia interface (HDMI), recommended standard 232 (RS-232), a plain old telephone service (POTS), and the like. The network 162 may include at least one of communication networks such as a computer network (e.g., a LAN or a WAN), the Internet, and a telephone network.

According to an embodiment of the present disclosure, the first electronic device 101 may further include a camera module. The camera module, for example, is a device that is capable of capturing a still image and a moving image. The camera module may include one or more image sensors (e.g., a front sensor or a back sensor), a lens, an image signal processor (ISP), or a flash (e.g., an LED, xenon lamp, and the like). The processor 120 may store a still image or a moving image captured through the camera module in the memory 130, or may transmit the same to the second electronic device 104 when a video call is executed.

Each of the second and third external electronic devices 104 and 105 respectively, may be of a type identical to, or different from, that of the first electronic device 101. According to an embodiment of the present disclosure, the server 106 may include a group of one or more servers. All or some of the operations executed in the first electronic device 101 may be executed in the second electronic device 104, the third electronic device 105, or the server 106. When the first electronic device 101 has to perform a certain function or service automatically or by request, the first electronic device 101 may request the second electronic device 104, the third electronic device 105, or the server 106 to perform at least some functions relating thereto, instead of, or in addition to, performing the function or service by itself. The second electronic device 104, the third electronic device 105, or the server 106 may execute the requested functions or the additional functions, and may deliver a result of the execution to the first electronic device 101. The first electronic device 101 may process the received result as it is or additionally to provide the requested function or service. To this end, for example, cloud computing, distributed computing, or client-server computing technology may be used.

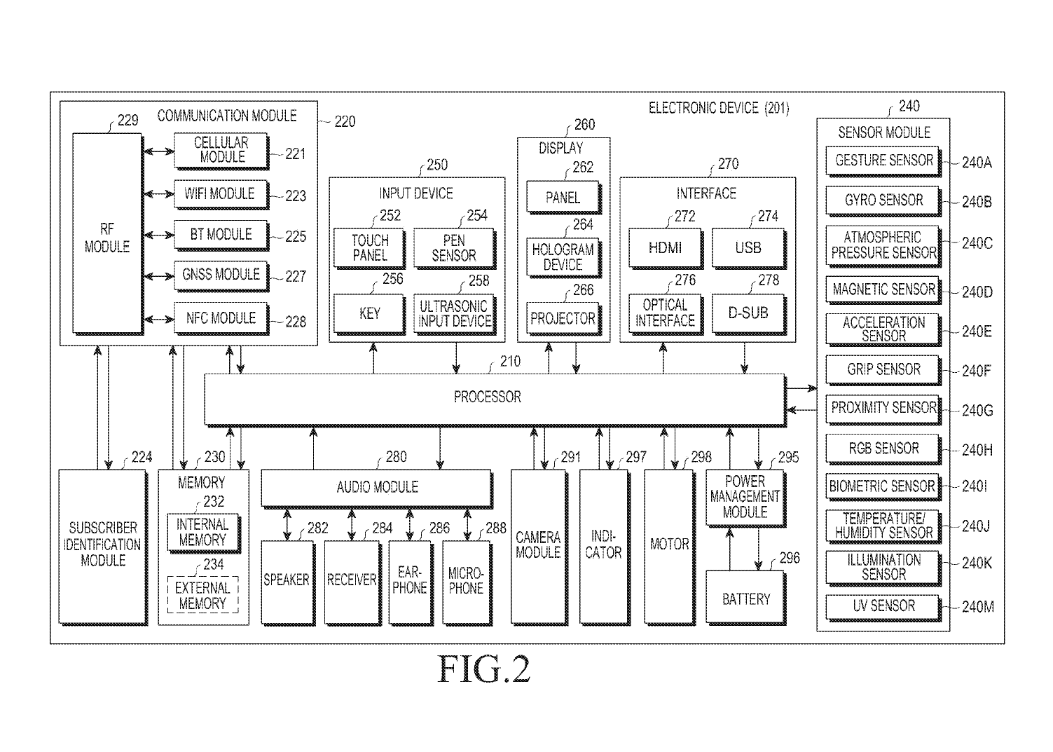

FIG. 2 is a block diagram of an electronic device, according to an embodiment of the present disclosure.

The electronic device 201 may include a part or the entirety of the first electronic device 101 of FIG. 1 or the second electronic device 104. The electronic device 201 includes at least one processor (e.g., an application processor (AP)) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control multiple hardware or software elements connected to the processor 210 by running, for example, an operation system or an application program, and may perform processing and operation on various data. The processor 210 may be embodied, for example, as a system on chip (SoC). According to an embodiment of the present disclosure, the processor 210 may further include a graphic processing unit (GPU) and/or an image signal processor. The processor 210 may also include at least some (e.g., a cellular module 221) of the elements illustrated in FIG. 2. The processor 210 may load instructions or data received from at least one of the other elements (e.g., a non-volatile memory) into a volatile memory, process the loaded instructions or data, and store various data in a non-volatile memory.

The communication module 220 may have a configuration equal or similar to that of the communication interface 170 of FIG. 1. The communication module 220 includes, for example, the cellular module 221, a WiFi module 223, a Bluetooth module 225, a GNSS module 227 (e.g., a GPS module, a Glonass module, a Beidou module, or a Galileo module), an NFC module 228, and a radio frequency (RF) module 229.

The cellular module 221 may provide a voice call, a video call, a text message service, an Internet service, and the like through a communication network. According to an embodiment of the present disclosure, the cellular module 221 may identify and authenticate the electronic device 201 within a communication network using a subscriber identification module (SIM) 224 (e.g., a SIM card). The cellular module 221 may perform at least some of the functions that the processor 210 may provide. The cellular module 221 may include a communication processor (CP).

The Wi-Fi module 223, the BT module 225, the GNSS module 227, or the NFC module 228 may include, for example, a processor for processing data that is transmitted and received through a corresponding module. At least some (e.g., two or more) of the cellular module 221, the Wi-Fi module 223, the BT module 225, the GNSS module 227, and the NFC module 228 may be included in one integrated chip (IC) or IC package.

The RF module 229, for example, may transmit/receive a communication signal (e.g., an RF signal). The RF module 229 may include, for example, a transceiver, a power amplifier module (PAM), a frequency filter, a low noise amplifier (LNA), an antenna, and the like. At least one of the cellular module 221, the Wi-Fi module 223, the BT module 225, the GNSS module 227, and the NFC module 228 may transmit/receive an RF signal through a separate RF module.

The SIM 224 may include, for example, a card including a subscriber identity module and/or an embedded SIM, and may contain unique identification information (e.g., an integrated circuit card identifier (ICCID)) or subscriber information (e.g., an international mobile subscriber identity (IMSI)).

The memory 230 (e.g., the memory 130) includes, for example, an internal memory 232 or an external memory 234. The internal memory 232 may include, for example, at least one of a volatile memory (e.g., a dynamic random access memory (DRAM), a static RAM (SRAM), a synchronous dynamic RAM (SDRAM), and the like) and a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash, a NOR flash memory, and the like), a hard disc drive, a solid state drive (SSD), and the like).

The external memory 234 may further include a flash drive, for example, a compact flash (CF), a secure digital (SD), a micro secure digital (Micro-SD), a mini secure digital (Mini-SD), an extreme digital (xD), a multi-media card (MMC), a memory stick, and the like. The external memory 234 may be functionally or physically connected to the electronic device 201 through various interfaces.

The sensor module 240 may measure a physical quantity or detect an operation state of the electronic device 201, and may convert the measured or detected information into an electrical signal. The sensor module 240 includes, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green, and blue (RGB) sensor), a biometric sensor 240I, a temperature/humidity sensor 240J, an illumination sensor 240K, and a ultraviolet (UV) sensor 240M. Additionally or alternatively, the sensor module 240A may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. The electronic device 201 may further include a processor, which is configured to control the sensor module 240, as a part of the processor 210 or separately from the processor 210, and may control the sensor module 240 while the processor 210 is in a sleep state.

The input device 250 includes, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. Furthermore, the touch panel 252 may further include a control circuit. The touch panel 252 may further include a tactile layer to provide a tactile reaction to a user.

The (digital) pen sensor 254 may include, for example, a recognition sheet, which is a part of the touch panel or is separated from the touch panel. The key 256 may include, for example, a physical button, an optical key, or a keypad. The ultrasonic input device 258 may detect ultrasonic waves, which are generated by an input tool, through a microphone 288 to identify data corresponding to the detected ultrasonic waves.

The display 260 (e.g., the display 160) includes a panel 262, a hologram device 264 or a projector 266. The panel 262 may include the same or a similar configuration to the display 160 illustrated in FIG. 1. The panel 262 may be implemented to be, for example, flexible, transparent, or wearable. The panel 262 and the touch panel 252 may be implemented as one module. The hologram device 264 may show a three dimensional image in the air by using an interference of light. The projector 266 may display an image by projecting light onto a screen. The screen may be located, for example, inside or outside the electronic device 201. According to an embodiment of the present disclosure, the display 260 may further include a control circuit for controlling the panel 262, the hologram device 264, or the projector 266.

The interface 270 includes, for example, a high-definition multimedia interface (HDMI) 272, a universal serial bus (USB) 274, an optical interface 276, or a D-subminiature (D-sub) 278. The interface 270 may be included, for example, in the communication interface 170 illustrated in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

For example, the audio module 280 may execute bidirectional conversion between a sound and an electrical signal. At least some elements of the audio module 280 may be included, for example, in the input/output interface 145 illustrated in FIG. 1. The audio module 280 may process sound information that is input or output through, for example, a speaker 282, a receiver 284, earphones 286, the microphone 288, and the like.

The camera module 291 is a device that may photograph a still image and a moving image. According to an embodiment of the present disclosure, the camera module 291 may include one or more image sensors (e.g., a front sensor or a back sensor), a lens, an image signal processor (ISP), or a flash (e.g., an LED, a xenon lamp, and the like).

The power management module 295 may manage, for example, the power of the electronic device 201. According to an embodiment of the present disclosure, the power management module 295 may include a power management integrated circuit (PMIC), a charger integrated circuit (IC), or a battery gauge. The PMIC may have a wired and/or wireless charging method. The wireless charging method may include, for example, a magnetic resonance method, a magnetic induction method, an electromagnetic wave method, and the like. Additional circuits (e.g., a coil loop, a resonance circuit, a rectifier, and the like.) for wireless charging may be further included. The battery gauge may measure, for example, a residual charge quantity of the battery 296, and a voltage, a current, or a temperature while charging. The battery 296 may include, for example, a rechargeable battery and/or a solar battery.

The indicator 297 may indicate a particular state (e.g., a booting state, a message state, a charging state, and the like) of the electronic device 201 or a part (e.g., the processor 210) thereof. The motor 298 may convert an electrical signal into a mechanical vibration and may generate a vibration, a haptic effect, etc. The electronic device 201 may include a processing device (e.g., a GPU) for supporting a mobile TV. The processing unit for supporting the mobile TV may process media data according to a standard, such as digital multimedia broadcasting (DMB), digital video broadcasting (DVB), MediaFlo™, and the like.

Each of the above-described component elements of hardware may be configured with one or more components, and the names of the corresponding component elements may vary based on the type of electronic device. In an embodiment of the present disclosure, the electronic device may include at least one of the above-described elements, and may exclude some of the elements or further include other additional elements. Further, some of the components of the electronic device may be combined to form a single entity, and thus, may equivalently execute functions of the corresponding elements prior to the combination.

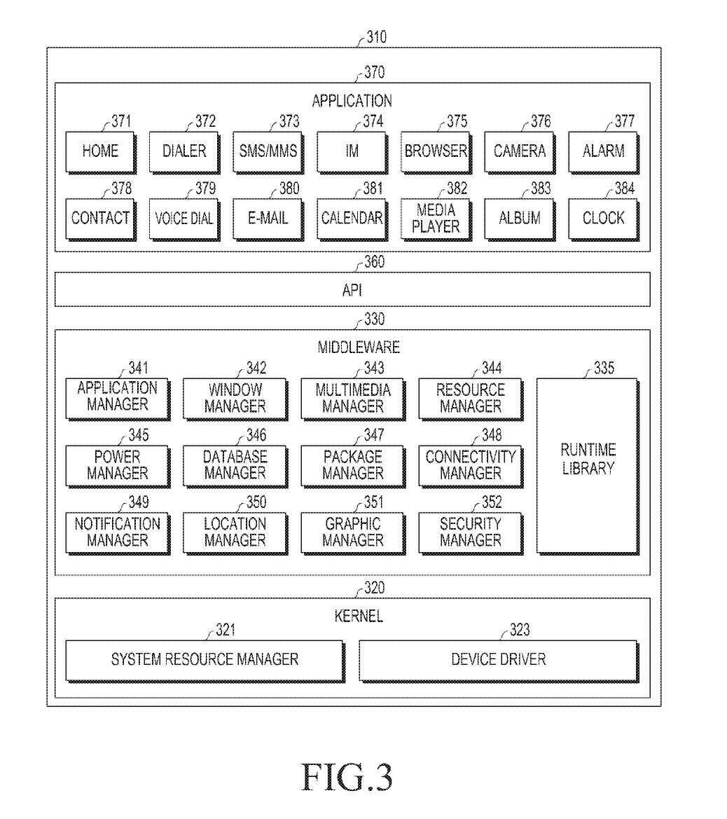

FIG. 3 is a block diagram of a program module, according to an embodiment of the present disclosure.

The program module 310 (e.g., the program 140) may include an operating system (OS) for controlling resources related to the electronic device (e.g., the first electronic device 101) and/or various applications (e.g., the application programs 147) executed in the operating system. The operating system may be, for example, Android™, iOS™, Windows™, Symbian™, Tizen™, Bada™, and the like.

The program module 310 includes a kernel 320, middleware 330, an application programming interface (API) 360, and/or an application 370. At least some of the program module 310 may be preloaded on the electronic device, or may be downloaded from the electronic device 105 or 104, or the server 106.

The kernel 320 (e.g., the kernel 141) includes, for example, a system resource manager 321 and/or a device driver 323. The system resource manager 321 may control, allocate, or retrieve system resources. According to an embodiment of the present disclosure, the system resource manager 321 may include a process manager, a memory manager, a file system manager, and the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

The middleware 330 may provide, for example, a function required by the applications 370 in common, or may provide various functions to the applications 370 through the API 360 such that the applications 370 may efficiently use limited system resources within the electronic device. According to an embodiment of the present disclosure, the middleware 330 (e.g., the middleware 143) includes, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses in order to add a new function through a programming language while the applications 370 are being executed. The runtime library 335 may perform functions that are related to the management of input and output, the management of a memory, arithmetic functions, and the like.

The application manager 341 may, for example, manage a life cycle of at least one of the applications 370. The window manager 342 may manage graphical user interface (GUI) resources used on a screen. The multimedia manager 343 may determine formats required to reproduce various media files and may encode or decode a media file using a coder/decoder (codec) appropriate for a corresponding format. The resource manager 344 may manage resources, such as the source code, the memory, the storage space, and the like of at least one of the applications 370.

The power manager 345 may operate together with, for example, a basic input/output system (BIOS) to manage a battery or power, and may provide power information required for the operation of the electronic device. The database manager 346 may generate, search for, or change a database to be used by at least one of the applications 370. The package manager 347 may manage the installation or updating of an application that is distributed in the form of a package file.

The connectivity manager 348 may manage a wireless connection, such as Wi-Fi, Bluetooth, and the like. The notification manager 349 may display or notify of an event, such as an arrival message, an appointment, a proximity notification, and the like, in such a manner as not to disturb a user. The location manager 350 may manage location information of the electronic device. The graphic manager 351 may manage a graphic effect to be provided to a user and a user interface relating to the graphic effect. The security manager 352 may provide various security functions required for system security, user authentication, and the like. According to an embodiment of the present disclosure, in a case where the first electronic device 101 has a telephone call function, the middleware 330 may further include a telephony manager for managing a voice or video call function of the electronic device.

The middleware 330 may include a middleware module that forms a combination of various functions of the above-described elements. The middleware 330 may provide modules that are specialized according to the types of operating systems in order to provide differentiated functions. Furthermore, the middleware 330 may dynamically remove some of the existing elements, or may add new elements.

The API 360 (e.g., the API 145) is, for example, a set of API programming functions, and may be provided as a different configuration according to an operating system. For example, in the case of Android™ or iOS, one API set may be provided for each platform, and in the case of Tizen™, two or more API sets may be provided for each platform.

The applications 370 (e.g., the application programs 147) includes one or more applications that may perform functions, for example, home 371, dialer 372, SMS/MMS 373, instant message (IM) 374, browser 375, camera 376, alarm 377, contacts 378, voice dial 379, e-mail 380, calendar 381, media player 382, album 383, clock 384, health care (e.g., measuring exercise quantity or blood sugar level), and environment information (e.g., atmospheric pressure, humidity, temperature information, and the like).

According to an embodiment of the present disclosure, the applications 370 may include an information exchange application supporting exchanging information between the first electronic device 101 and the electronic device 104 or 105. The information exchange application may include, for example, a notification relay application for transferring specific information to an external electronic device or a device management application for managing an external electronic device.

For example, the notification relay application may include a function of delivering, to the electronic device 104 or 105, notification information generated by other applications (e.g., an SMS/MMS application, an email application, a health care application, an environmental information application, and the like) of the electronic device. Furthermore, the notification relay application may, for example, receive notification information from an external electronic device and may provide the received notification information to a user.

For example, the device management application may manage (e.g., install, delete, or update) at least one function of the electronic device 104 or 105 communicating with the electronic device (e.g., a function of turning on/off the external electronic device itself (or some components) or a function of adjusting luminance (or a resolution) of a display), applications operating in the external electronic device, or services provided by the external electronic device (e.g., a call service and a message service).

According to an embodiment of the present disclosure, the applications 370 may include applications (e.g., a health care application of a mobile medical appliance, and the like) that are specified according to attributes of the electronic device 104 or 105. The applications 370 may include applications that are received from the server 106, or the electronic device 104 or 105. The applications 370 may include preloaded applications or third-party applications that may be downloaded from a server. The names of the elements of the program module 310, according to the above-described embodiment, may change depending on the type of operating system.

According to an embodiment of the present disclosure, at least a part of the program module 310 may be embodied as software, firmware, hardware, or a combination of two or more thereof. At least some of the program module 310 may be implemented (e.g., executed) by, for example, a processor (e.g., the processor 210). At least some of the program module 310 may include, for example, a module, a program, a routine, a set of instructions, or a process for performing one or more functions.

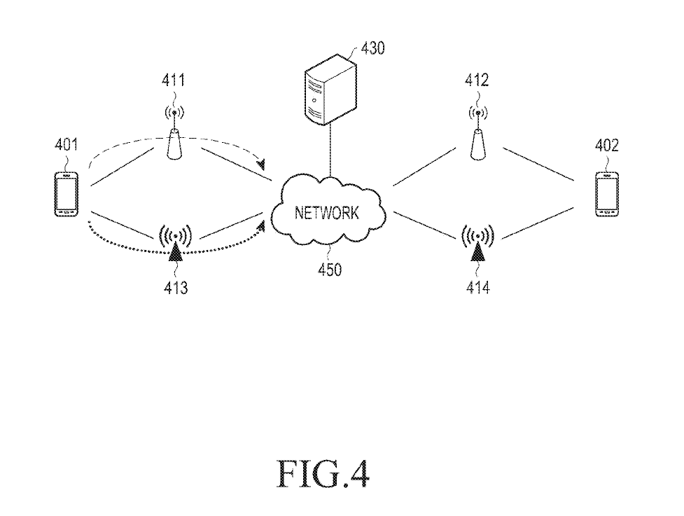

FIG. 4 is a diagram illustrating a connection between electronic devices, according to an embodiment of the present disclosure.

Referring to FIG. 4, a first communication module (e.g., the first communication module 171) of a first electronic device 401 accesses a first base station 411 that supports cellular communication, and thus, may be connected to the network 450, for example, a circuit switched (CS) network or a packet switched (PS) network. The network 450 may be connected to a server 430, for example, a message server or a video call service server. According to an embodiment of the present disclosure, the first electronic device 401 requests the server 430 to provide a video call service with a second electronic device 402. The video call service request from the first electronic device 401 may be transmitted to the server 430 through the first base station 411 or the network 450. The server 430 may transfer the video call service request to the network 450 or a second base station 412 that is capable of performing cellular communication. The second base station 412 informs the second electronic device 402 that the video call service request for a video call with the second electronic device 402 is received from the first electronic device 401.

Referring to FIG. 4, a first communication module (e.g., the first communication module 171) of the second electronic device 402 accesses the second base station 412 that supports cellular communication, and thus, may be connected to the network 450, for example, a CS network or a PS network. The network 450 may be connected to the server 430, for example, a message server or a video call service server. The second electronic device 402 may be requested, by the second base station 412, to perform a video call service with the first electronic device 401. The second base station 412 transfers a video call service response to the server 430 through the network 450. The server 430 may transfer the video call service response to the first electronic device 401 through the first base station 411 that is capable of performing cellular communication.

According to an embodiment of the present disclosure, the first electronic device 401 may be connected with a base station that provides a communication service (e.g., WiFi), and may transmit and receive an image generated when a video call is performed. In FIG. 4, the first electronic device 401 may access the network 450 through, for example, a third base station 413 that supports WiFi communication, and thus, may transmit and receive an image generated when a video call with the second electronic device 402 is executed. In the same manner, the second electronic device 402 may access the network 450 through, for example, a fourth base station 414 that supports WiFi communication, and thus, may transmit and receive an image generated when a video call with the first electronic device 401 is executed.

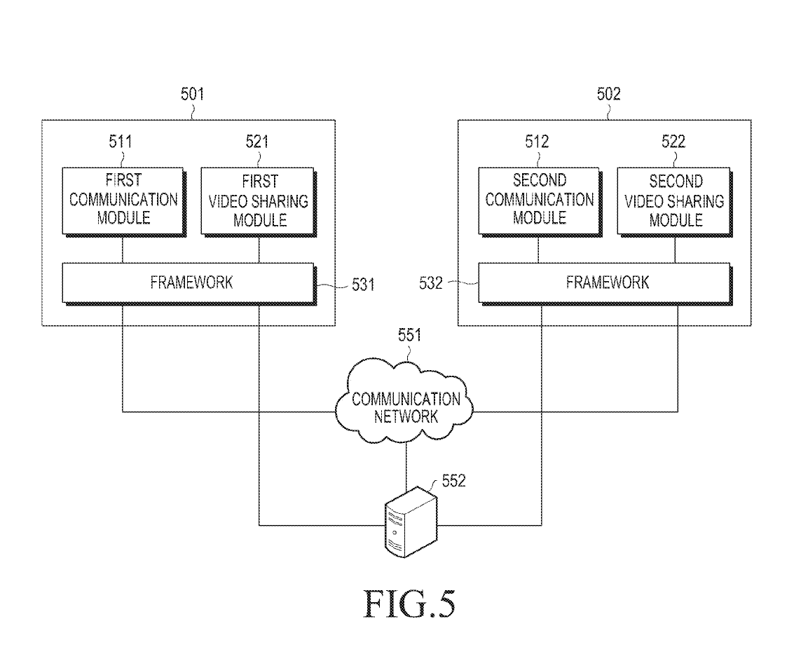

FIG. 5 is a diagram illustrating a connection between electronic devices, according to another embodiment of the present disclosure.

Referring to FIG. 5, a first electronic device 501 includes a first communication module 511 and a first video sharing module 521. A second electronic device 502 includes a second communication module 512 and a second video sharing module 522. According to an embodiment of the present disclosure, the first and second communication modules 511 and 512 may be embodied in a form of a call application, and the first and second video sharing modules 521 and 522 may be embodied in a form of an SWIS application. The first and second communication modules 511 and 512 and the first and second video sharing modules 521 and 522 may be installed separately from the frameworks 531 and 532 of the electronic devices 501 and 502, and may be executed by a processor (e.g., the processor 120) of a corresponding electronic device 501 and 502.

Referring to FIG. 5, the first electronic device 501 accesses a communication network 551 using the first communication module 511, and thus, may be connected to the second electronic device 502 that accesses to the communication network 551 through the second communication module 512. The first electronic device 501 and the second electronic device 502 may perform a voice call function between the first electronic device 501 and the second electronic device 502 through the first communication module 511 and the second communication module 512, respectively.

Referring to FIG. 5, the first electronic device 501 is connected to a video call service provider 552 (e.g., the server 106) using the first video sharing module 521, and thus, may be connected to the second electronic device 502 that is connected to the video call service provider 552 through the second video sharing module 522. The first electronic device 501 and the second electronic device 502 may perform a video call function between the first electronic device 501 and the second electronic device 502 through the first video sharing module 521 and the second video sharing module 522, respectively.

An electronic device, according to an embodiment of the present disclosure, may include a communication interface configured to support a plurality of communication schemes and a processor. The processor is configured to receive, through the communication interface, a request message for a video call between the electronic device and a first external electronic device from a second electronic device, select a first wireless communication scheme to be used for a communication connection for the video call from among the plurality of communication schemes, identify connection information allocated to the electronic device by a third external electronic device connected to the electronic device, using the first wireless communication scheme, and control the communication interface to transmit, to the second external electronic device, a response message in response to the request message such that at least part of the connection information is used for establishing the communication connection.

According to an embodiment of the present disclosure, the plurality of communication schemes include a WiFi communication scheme, and the processor is further configured to recognize a base station or an access point, which supports the WiFi communication scheme, as the third external electronic device.

According to an embodiment of the present disclosure, the plurality of communication schemes include a cellular communication scheme, and the processor is further configured to recognize a base station or an access point, which supports the cellular communication scheme, as the third external electronic device.

According to an embodiment of the present disclosure, during or after the communication connection for the video call is established based on the connection information, if a second wireless communication scheme is available from among the plurality of communication schemes excluding the first wireless communication scheme, the processor is further configured to control the communication interface to transmit another request for establishing the communication connection to the third external electronic device using the second wireless communication scheme.

According to an embodiment of the present disclosure, the processor is further configured to control the communication interface to interrupt the communication connection which is being established or completely established using the first wireless communication scheme.

According to an embodiment of the present disclosure, the processor is further configured to, while a voice call is connected between the electronic device and the first external electronic device, control the communication interface to receive the request message, using a second wireless communication scheme from among the plurality of communication schemes, excluding the first wireless communication scheme.

According to an embodiment of the present disclosure, the first wireless communication scheme includes a Wi-Fi communication scheme, the second wireless communication scheme includes a cellular communication scheme, the communication interface includes a first communication module for supporting the Wi-Fi communication scheme and a second communication module for supporting the cellular communication scheme, and the processor is configured to determine the connection information using the first communication module, and connect the voice call using the second communication module.

According to an embodiment of the present disclosure, the processor is further configured to determine a type of electronic device of the third external electronic device, and if the third external electronic device includes an access point of a provider that provides at least one communication service, obtain another connection information allocated to the electronic device by a fourth external electronic device that is connected to the electronic device, using the first communication scheme.

According to an embodiment of the present disclosure, the processor is further configured to display an object associated with execution of the video call, through a display that is functionally connected with the processor, in response to receiving the request message.

According to an embodiment of the present disclosure, the processor is further configured to control the communication interface to transmit the response message to the first external electronic device, based on a user input for selecting the object.

According to an embodiment of the present disclosure, the processor is further configured to control the display to display the object after a communication connection for the video call is established.

An electronic device according to another embodiment of the present disclosure includes a processor configured to transmit, through the at least one communication interface, a request message for a second communication connection for a video call with a first external electronic device to a second external electronic device, in a state in which a first communication connection for a voice call between the electronic device and the first external electronic device is established using a first wireless communication scheme through the at least one communication interface, and if a response message in response to the request message is received from the second external electronic device, control the at least one communication interface to establish the second communication connection based on the response message.

According to an embodiment of the present disclosure, the processor is further configured to establish the second communication connection in a state in which the first communication connection is maintained.

According to an embodiment of the present disclosure, the first wireless communication scheme includes a circuit switching communication scheme and the processor is further configured to recognize a base station or an access point, which supports the circuit switching communication scheme, as a third external electronic device for the first communication connection with the first external electronic device.

According to an embodiment of the present disclosure, the plurality of communication schemes include a packet switching communication scheme and the processor is further configured to recognize a base station or an access point, which supports the packet switching communication scheme, as the second external electronic device.

According to an embodiment of the present disclosure, the first wireless communication scheme includes a cellular communication scheme and the processor is further configured to recognize a base station or an access point, which supports the cellular communication scheme as a third external electronic device for the first communication connection with the first external electronic device.

According to an embodiment of the present disclosure, the plurality of communication schemes include a WiFi communication scheme, and the processor is further configured to recognize a base station or an access point, which support the WiFi communication scheme, as the second external electronic device.

According to an embodiment of the present disclosure, the plurality of communication schemes include a cellular communication scheme, and the processor is configured to recognize a base station or an access point, which supports the cellular communication scheme, as the second external electronic device.

According to an embodiment of the present disclosure, the plurality of communication schemes include a BT communication scheme or a Bluetooth low energy (BLE) communication scheme, and the processor is configured to recognize a base station or an access point, which supports the BT communication scheme or the BLE communication scheme, as the second external electronic device.

According to an embodiment of the present disclosure, the plurality of communication schemes include a near field communication (NFC) communication scheme, and the processor is configured to recognize a base station or an access point, which supports the NFC communication scheme, as the second external electronic device.

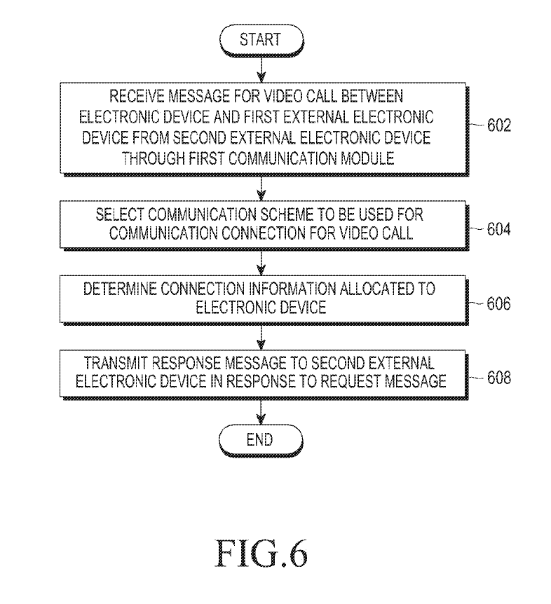

FIG. 6 is a flowchart of a method in which an electronic device converts a voice call into a video call, according to an embodiment of the present disclosure.

Referring to FIG. 6, the first electronic device 101 receives, from a second external electronic device, a request message for a video call between the first electronic device 101 and a first external electronic device (e.g., the second electronic device 104), through the communication interface 170 that supports a plurality of communication schemes in step 602. The second external electronic device may be, for example, a base station or an access point that supports a packet switching communication scheme, a base station or an access point that supports a WiFi communication scheme, a base station or an access point that supports a cellular communication scheme, a base station or an access point that supports a BT communication scheme or a BLE communication scheme, a base station or an access point that supports an NFC communication scheme, and the like.

In step 604, the first electronic device 101 selects a communication scheme to be used for a communication connection for a video call with the first external electronic device, from among a plurality of communication schemes supported through the communication interface 170.

In step 606, the first electronic device 101 determines connection information allocated to the first electronic device 101 by a third external electronic device that is connected to the first electronic device 101 in communication, using the communication scheme selected in step 604. The third external electronic device may be, for example, a base station or an access point that supports a circuit switching communication scheme, a base station or an access point that supports a cellular communication scheme, and the like.

In step 608, the first electronic device 101 generates a response message in response to the request message, and transmits the same to the second external electronic device so that at least a part of the connection information is used for establishing the communication connection.

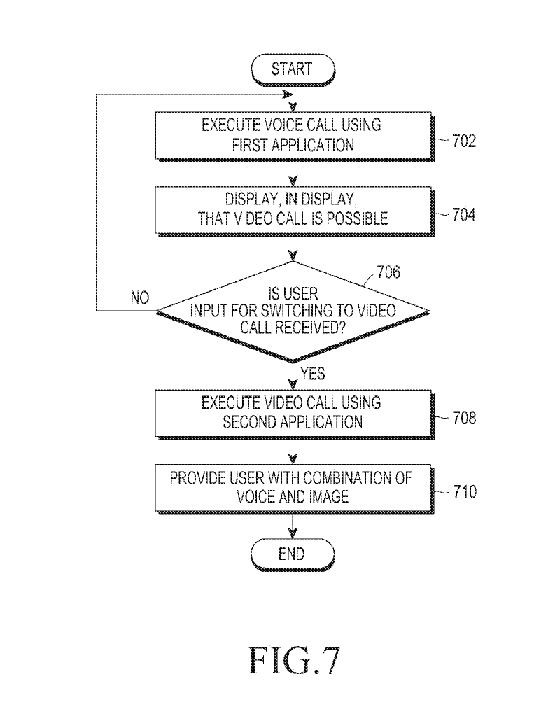

FIG. 7 is a flowchart of a method in which an electronic device converts a voice call into a video call, according to another embodiment of the present disclosure.

In FIG. 7, it is assumed that the first electronic device 101 and the second electronic device 104 execute a voice call or a video call.

Referring to FIG. 7, the first electronic device 101 executes a voice call using a first application in step 702. The first application may be, for example, an application that provides a voice call function or a communication module (e.g., the communication module 511) that provides the voice call function. A user executes the first application, and inputs, into the first electronic device 101, a user input for selecting an object associated with the execution of a voice call from among user interfaces (UIs) provided in the first application, and thus, the voice call with, for example, the second electronic device 104 may be executed.

According to an embodiment of the present disclosure, the first electronic device 101 may determine whether a video call is executable. When the first electronic device 101 determines that a video call is executable, the first electronic device 101 may display that a video call is executable in the display 160 in step 704. For example, the first electronic device 101 may control the display 160 to add and display, in a UI of the first application, an object (e.g., an icon and the like) for switching to a video call.

According to an embodiment of the present disclosure, in advance of step 704, the first electronic device 101 may determine whether the first electronic device 101 is capable of executing a video call function. To determine whether to execute a video call function of the first electronic device 101, the first electronic device 101 may check a wireless environment of the first electronic device 101, a state of a connection with the server 106, a function of the first electronic device, and the like. The first electronic device 101 may check a type of communication network connected to the first electronic device 101 (e.g., LTE, 3G, WiFi, and the like), a channel quality (e.g., RSSI, SNR, signal strength, and the like), of the wireless environment of the first electronic device 101. The first electronic device 101 may check whether a user of the first electronic device 101 logs on to a server 106 associated with an application that provides a video call, whether the server is an IP multimedia subsystem (IMS) server or an over the top (OTT) server, and the like, as the state of a connection with a server 106. The first electronic device 101 may check a camera function (e.g., a resolution, a frame rate, and the like), a mobile device management (MDM) state, a residual charge quantity of a battery, location information, call reception settings (e.g., automatic refusal and the like), as the function of the first electronic device 101.

When the first electronic device 101 is capable of performing a video call function, the first electronic device 101 determines whether a user input for switching into a video call is received in step 706. When the result of the determination in step 706 shows that the user input for switching into a video call is not received (No in step 706), the first electronic device 101 maintains executing a voice call using the first application as in step 702.

When the result of the determination in step 706 shows that the user input for switching into a video call is received (Yes in step 706), the first electronic device 101 executes a video call using a second application in step 708. When the video call is executed, the first electronic device 101 may combine a voice through the first application and an image through the second application, and provides the same to the user in step 710.

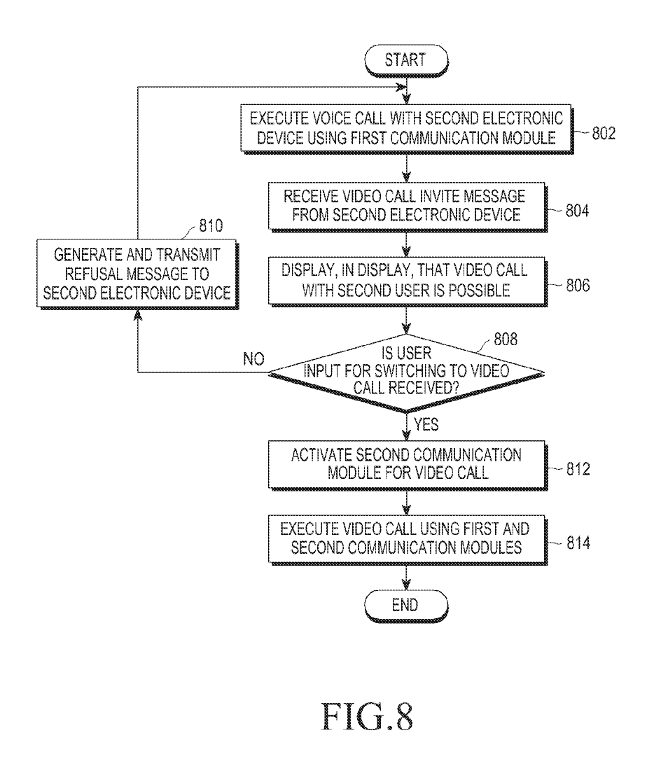

FIG. 8 is a flowchart of a method in which an electronic device converts a voice call into a video call, according to another embodiment of the present disclosure.

In FIG. 8, it is assumed that the first electronic device 101 and the second electronic device 104 execute a voice call or a video call.

Referring to FIG. 8, the first electronic device 101 executes a voice call with the second electronic device 104 using the first communication module 171 in step 802. According to an embodiment of the present disclosure, the first communication module 171 may receive audio (e.g., voice data) from the second electronic device 104, or may transmit audio to the second electronic device 104.

In step 804, the first electronic device 101 receives an invite message for a video call from the second electronic device 104. When the invite message is received, the first electronic device 101 informs a user of the first electronic device 101 that a video call request is received from the second electronic device 104. According to an embodiment of the present disclosure, when the first electronic device 101 receives the invite message, the first electronic device 101 determines whether the first electronic device 101 is capable of executing a video call. When it is determined that a video call function is executable, the first electronic device 101 displays, in the display 160, that a video call is executable in step 806 so that the user (a first user) of the first electronic device 101 may be informed that a video call is possible. When it is determined that the video call function is not executable, the first electronic device 101 informs the second electronic device 104 that the video call function is not executable through the first communication module 171.

In step 806, the first electronic device 101 displays that a video call with a second user is possible in a UI of an application associated with a voice call through the display 160. In step 808, the first electronic device 101 determines whether a user input for switching into a video call is received.

When the result of the determination in step 808 shows that the user input for switching into a video call is not received (No in step 808), the first electronic device 101 generates a refusal message for refusing the video call and controls the communication interface 170 to transmit the refusal message to the second electronic device 104 in step 810. Subsequently, the first electronic device 101 and the second electronic device 104 maintains a voice call in step 802.

When the result of the determination in step 808 shows that the user input for switching into a video call is received (Yes in step 808), the first electronic device 101 activates the second communication module 172 for the video call in step 812. According to an embodiment of the present disclosure, when communication for a video call is executable through the second communication module 172, the first electronic device 101 may set the second communication module 172 so that the second communication module 172 transmits and receives data through a second communication scheme (e.g., WiFi, BT, BLE, NFC, and the like) for a video call. When the communication for a video call is not executable through the second communication module 172 (e.g., when the second communication module 172 already executes another function), the first electronic device 101 may change the setting of the second communication module 172 so that the second communication module 172 is used based on the second communication scheme (e.g., WiFi, BT, BLE, NFC, and the like). According to an embodiment of the present disclosure, the second communication module 172 may receive an image (e.g., a still image, a moving image) from the second electronic device 104, or may transmit an image to the second electronic device 104.

In step 814, the first electronic device 101 executes a video call using the first communication module 171 and the second communication module 172. According to an embodiment of the present disclosure, the first electronic device 101 transmits and receives audio (e.g., voice data) through the first communication module 171, and transmits and receives an image (e.g., a still image, a moving image) through the second communication module 172. The processor 120 may control the first electronic device 101 to combine audio received through the first communication module 171 and an image received through the second communication module 172, and to display the same. The first electronic device 101 may synchronize the audio and image, and may control the display 160 to output the synchronized data.

According to an embodiment of the present disclosure, the first communication module 171 may receive audio and information associated with the audio, for example, a time at which audio is input, and the like, from the second electronic device 104. Also, the second communication module 172 may receive an image and information associated with the image, for example, a time at which an image is input, and the like, from the second electronic device 104. The first electronic device 101 may synchronize the audio and the image based on a time at which the audio is input and a time at which the image is input.

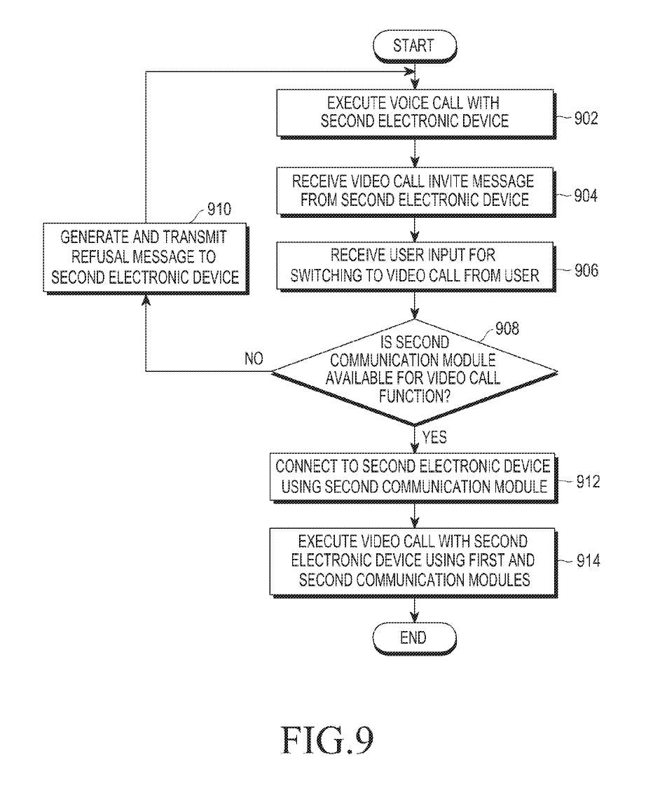

FIG. 9 is a flowchart of a method in which an electronic device converts a voice call into a video call, according to an embodiment of the present disclosure.

In FIG. 9, it is assumed that the first electronic device 101 and the second electronic device 104 execute a voice call or a video call.

Referring to FIG. 9, the first electronic device 101 executes a voice call with the second electronic device 104 using the first communication module 171 in step 902. According to an embodiment of the present disclosure, the first communication module 171 may receive audio (e.g., voice data) from the second electronic device 104, or may transmit audio to the second electronic device 104.

In step 904, the first electronic device 101 receives an invite message for a video call from the second electronic device 104. When the invite message is received, the first electronic device 101 informs a user of the first electronic device 101 that a video call request is received from the second electronic device 104.

When a user input for switching into a video call is received from a user of the first electronic device 101 in step 906, the first electronic device 101 determines whether the second communication module 172 is capable of a video call function in step 908.

When it is determined that the second communication module 172 is not capable of the video call function in step 908 (No in step 908), for example, when the second communication module 172 already executes another function, the first electronic device 101 generates a refusal message for reporting that the video call is not executable, and transmits the same to the second electronic device 104 in step 910. The refusal message may be transmitted, to the second electronic device 104, through the first communication interface 171. According to an embodiment of the present disclosure, the first electronic device 101 maintains a voice call with the second electronic device 104 in step 902.

When it is determined that the second communication module 172 is capable of the video call function in step 908 (Yes in step 908), the first electronic device 101 connects the first electronic device 101 to the second electronic device 104 using the second communication module 172 in step 912. According to an embodiment of the present disclosure, in step 912, the second communication module 172 establishes a second channel with the second electronic device 104, that is, a communication channel for transmitting and receiving an image.

When the first electronic device 101 and the second electronic device 104 are connected through the second communication module, the first electronic device 101 (e.g., the processor 120) executes a video call with the second electronic device 104 using the first communication module 171 and the second communication module 172 in step 914.

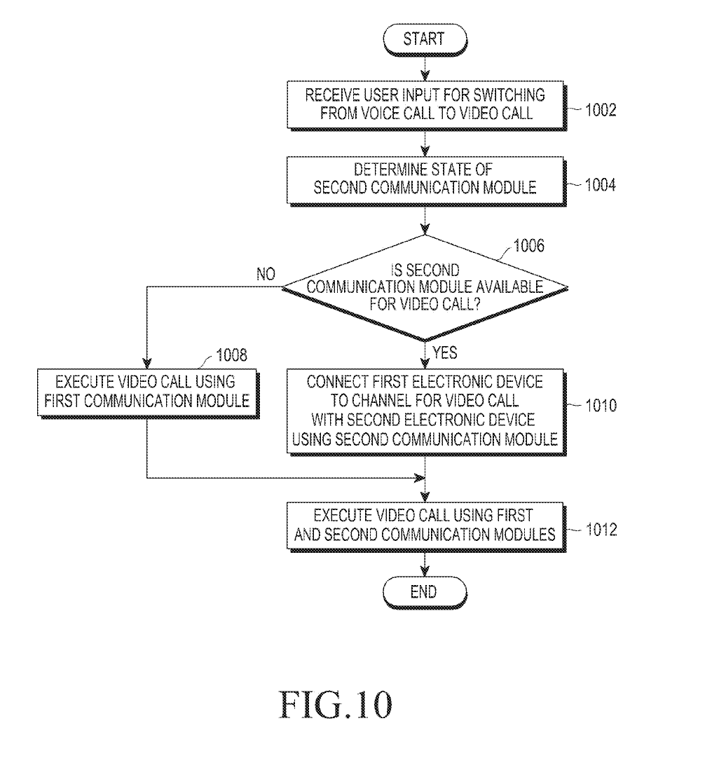

FIG. 10 is a flowchart of a method in which an electronic device converts a voice call into a video call, according to an embodiment of the present disclosure.

In FIG. 10, it is assumed that the first electronic device 101 and the second electronic device 104 execute a voice call or a video call.

Referring to FIG. 10, the first electronic device 101 receives a user input for switching a voice call into a video call in step 1002. In step 1004, the first electronic device 101 determines a state of the second communication module 172 that may be used for a video call. In step 1004, the first electronic device 101 determines a current state of the second communication module 172. In step 1006, the first electronic device 101 (e.g., the processor 120) determines whether the second communication module 172 is capable of a video call.

When the result of the determination in step 1006 shows that the second communication module 172 is not capable of a video call (No in step 1006), the first electronic device 101 (e.g., the processor 120) executes a video call using the first communication module 171 in step 1008. According to an embodiment of the present disclosure, in advance of step 1008, the first electronic device 101 receives a user input associated with whether to execute a video call through the first communication module 171, through, for example, the input/output interface 150 or the display 160. When the video call through the second communication module 172 is not executable, the first electronic device 101 controls the first electronic device 101 to inform the user of the first electronic device 101 that the video call through the second communication module is not executable. For example, the first electronic device 101 may control the display 160 to display a notification including “WiFi is not connected. Will you proceed with a video call through LTE connection?”. When a user agrees to proceed with a video call using the first communication module 171, the processor 120 may control the first electronic device 101 to proceed with the video call using the first communication module 171. When the user does not agree to proceed with the video call using the first communication module 171, the processor 120 may maintain a voice call using the first communication module 171.

An invite message for a video call may be received from the second electronic device 104. When the invite message is received, the first electronic device 101 informs a user of the first electronic device 101 that a video call request is received from the second electronic device 104.

When the result of the determination in step 1006 shows that the second communication module 172 is capable of the video call (Yes in step 1006), the first electronic device 101 connects the first electronic device 101 to a channel (a second channel) for a video call with the second electronic device 104 through the second communication module 172 in step 1010. In step 1012, the first electronic device 101 executes a video call with the second electronic device 101 using the first communication module 171 and the second communication module 172. According to an embodiment of the present disclosure, in step 1012, the first electronic device 101 transmits and receives audio to/from the second electronic device 104 through a first channel using the first communication module 171, and transmits and receives an image to/from the second electronic device 104 through the second channel using the second communication module 172.

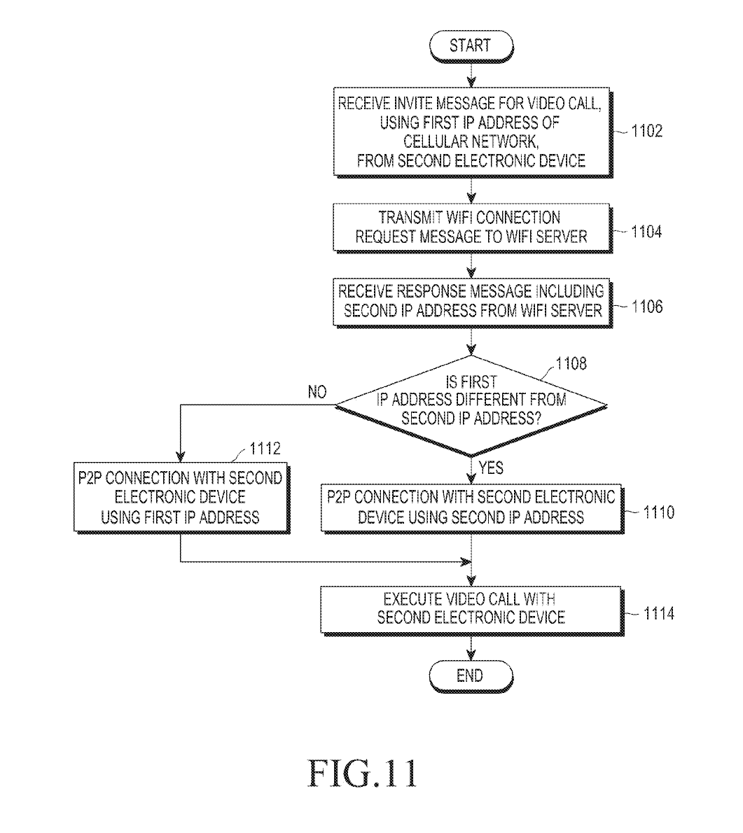

FIG. 11 is a flowchart of a method in which an electronic device converts a voice call into a video call, according to an embodiment of the present disclosure. In FIG. 11, it is assumed that the first electronic device 101 and the second electronic device 104 execute a voice call or a video call.

Referring to FIG. 11, in step 1102, the first electronic device 101 receives an invite message for a video call, using a first Internet protocol (IP) address of a cellular network, from the second electronic device 104 through the communication interface 170. According to an embodiment of the present disclosure, the first electronic device 101 determines whether the second communication module 172 is capable of the video call. When the second communication module 172 is capable of the video call, the first electronic device 101 may execute an operation for using the second communication module 172 for the video call (e.g., an operation of connecting a WiFi server and the first electronic device 101 through the second communication module 172, and the like).

In step 1104, the first electronic device 101 (e.g., the second communication module 172) transmits a WiFi connection request message to the WiFi server. In step 1106, the first electronic device 101 (e.g., the second communication module 172) receives a response message including a second IP address from the WiFi server.

In step 1108, the first electronic device 101 determines whether the first IP address and the second IP address are different from each other. When the result of the determination in step 1108 shows that the first IP address and the second IP address are different from each other (Yes in step 1108), the first electronic device 101 sets a peer to peer (P2P) connection with the second electronic device 104 using the second IP address in step 1110. When the P2P connection between the first electronic device 101 and the second electronic device 104 is established, the first electronic device 101 may execute a video call with the second electronic device 104 in step 1114.

When the result of the determination in step 1108 shows that the first IP address and the second IP address are identical to each other (No in step 1108), the first electronic device 101 sets a P2P connection with the second electronic device 104 using the first IP address in step 1112. When the P2P connection between the first electronic device 101 and the second electronic device 104 is established, the first electronic device 101 may execute a video call with the second electronic device 104 in step 1114.

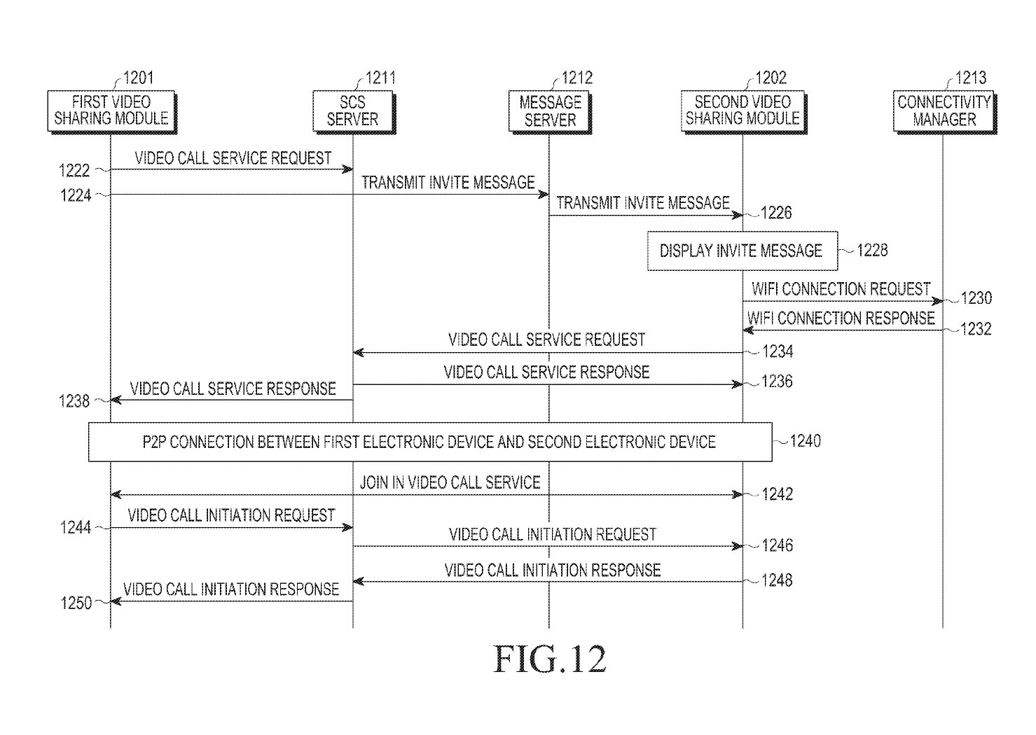

FIG. 12 is a flow diagram of a method in which electronic devices proceed with a video call, according to an embodiment of the present disclosure.

In FIG. 12, the first electronic device 101 may include a first video sharing module 1201. The first video sharing module 1201 is an application for a video call, and may be embodied in a form including a first SWIS application. The first SWIS application may include an SWIS agent. Also, the second electronic device 104 may include a second video sharing module 1202. The second video sharing module 1202 is an application for a video call, and may be embodied in a form including a second SWIS application. The second SWIS application may include an SWIS agent.

Referring to FIG. 12, the first video sharing module 1201 requests an SCS server 1211 to provide a video call service in step 1222. Also, in step 1224, the first video sharing module 1201 transmits, to a message server 1212, an invite message for inviting the second electronic device 104 as a partner of the video call.

In step 1226, the message server 1212 transmits the invite message to the second video sharing module 1202 of the second electronic device 104. In step 1228, a display of the second electronic device 104 displays the invite message that requests a video call with the first electronic device 101 received from the first electronic device 101.

According to an embodiment of the present disclosure, the second video sharing module 1202 transfers a request for a communication connection of the second electronic device 104, for example, a WiFi connection request for a WiFi communication connection, to a connectivity manager 1213 that is previously installed in the second electronic device 104, for a video call with the first electronic device 101 in step 1230. The connectivity manager 1213 may connect a WiFi server and the second electronic device 104 so that the second electronic device 104 performs WiFi communication in response to the request from the second video sharing module 1202. When the second electronic device 104 and the WiFi server are connected to each other, the connectivity manager 1213 transmits a WiFi connection response to the second video sharing module 1202, in response to the WiFi connection request, in step 1232.

According to an embodiment of the present disclosure, the second video sharing module 1202 requests an SCS server 1211 to provide a video call service in step 1234. In step 1236, the second video sharing module 1202 receives a video call service response from the SCS server 1212 in response to the video call service request.

In step 1238, the SCS server 1211 transmits, to the first video sharing module 1201, a video call service response as a response to step 1222. Subsequently, a P2P connection between the first electronic device 101 and the second electronic device 104 is established in step 1240. As described above, when the first electronic device 101 and the second electronic device 104 are connected, the first video sharing module 1201 and the second video sharing module 1202 join in a video call service provided by the SCS server 1211 in step 1242. In step 1244, the first video sharing module 1201 requests the SCS server 1211 to initiate a video call with the second electronic device 104. Subsequently, the SCS server 1211 transmits the video call initiation request to the second video sharing module 1202 of the second electronic device 104 in step 1246. When a video call initiation response corresponding to the video call initiation request is transmitted from the second video sharing module 1202 to the SCS server 1211 in step 1248, the SCS server 1211 transmits the video call initiation response to the first video sharing module 1201 of the first electronic device 101 in step 1250. Therefore, the video call may be executed between the first electronic device 101 and the second electronic device 104. The video call service may be provided to each of users through the first video sharing module 1201 of the first electronic device 101 and the second video sharing module 1202 of the second electronic device 104, respectively.

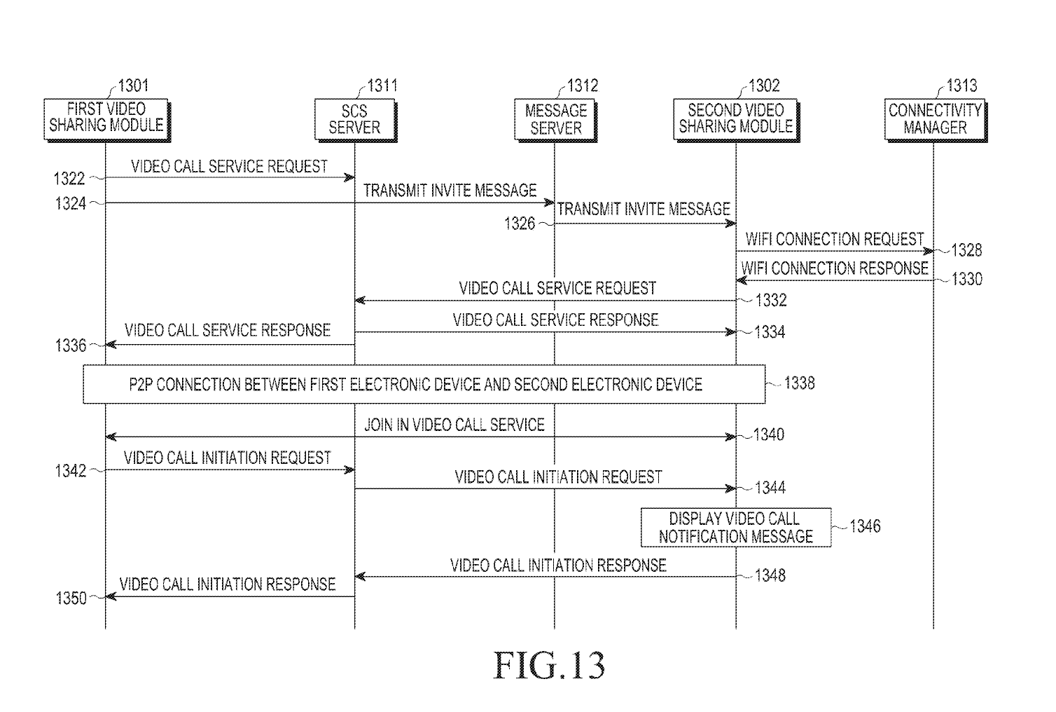

FIG. 13 is a flow diagram of a method in which electronic devices establish a video call, according to an embodiment of the present disclosure.

In FIG. 13, the first electronic device 101 may include a first video sharing module 1301. The first video sharing module 1301 is an application for a video call, and may be embodied in a form including a first SWIS application. The first SWIS application may include an SWIS agent. The second electronic device 104 may include a second video sharing module 1302. The second video sharing module 1302 is an application for a video call, and may be embodied in a form including a second SWIS application. The second SWIS application may include an SWIS agent.

Referring to FIG. 13, the first image sharing module 1301 requests an SCS server 1311 to provide a video call service in step 1322. In step 1324, the first video sharing module 1301 transmits, to a message server 1312, an invite message for inviting the second electronic device 104 as a partner of the video call.

In step 1326, the message server 1312 transmits the invite message to the second video sharing module 1302 of the second electronic device 104. According to an embodiment of the present disclosure, the second video sharing module 1302 transfers a request for a communication connection of the second electronic device, for example, a WiFi connection request for a WiFi connection, to a connectivity manager 1313 that is previously installed in the second electronic device 104, for a video call with the first electronic device 101 in step 1328. The connectivity manager 1313 may connect a WiFi server and the second electronic device 104 so that the second electronic device 104 performs WiFi communication in response to the request from the second video sharing module 1302. When the second electronic device 104 and the WiFi server are connected to each other, the connectivity manager 1313 may transmit a WiFi connection response corresponding to the WiFi connection request to the second video sharing module 1302 in step 1330.

According to an embodiment of the present disclosure, the second video sharing module 1302 requests an SCS server 1311 to provide a video call service in step 1332. In step 1334, the second video sharing module 1302 receives a video call service response corresponding to the video call service request from the SCS server 1312.

In step 1336, the SCS server 1311 transmits, to the first video sharing module 1301, a video call service response as a response to step 1322. Subsequently, a P2P connection between the first electronic device 101 and the second electronic device 104 is established in step 1338. As described above, when the first electronic device 101 and the second electronic device 104 are connected, the first video sharing module 1301 and the second video sharing module 1302 join in a video call service provided by the SCS server 1311 in step 1340. In step 1342, the first video sharing module 1301 requests the SCS server 1311 to initiate a video call with the second electronic device 104. Subsequently, the SCS server 1311 transmits the video call initiation request to the second video sharing module 1302 of the second electronic device 104 in step 1344. The second video sharing module 1302 displays a video call notification message reporting that a video call initiation request is received from the first electronic device 101, in a display of the second electronic device 104, in step 1346.

When a video call initiation response corresponding to the video call initiation request is transmitted from the second video sharing module 1302 to the SCS server 1311 in step 1348, the SCS server 1311 transmits the video call initiation response to the first video sharing module 1301 of the first electronic device 101 in step 1350. Therefore, the video call may be executed between the first electronic device 101 and the second electronic device 104. The video call service may be provided to each of users through the first video sharing module 1301 of the first electronic device 101 and the second video sharing module 1302 of the second electronic device 104, respectively.

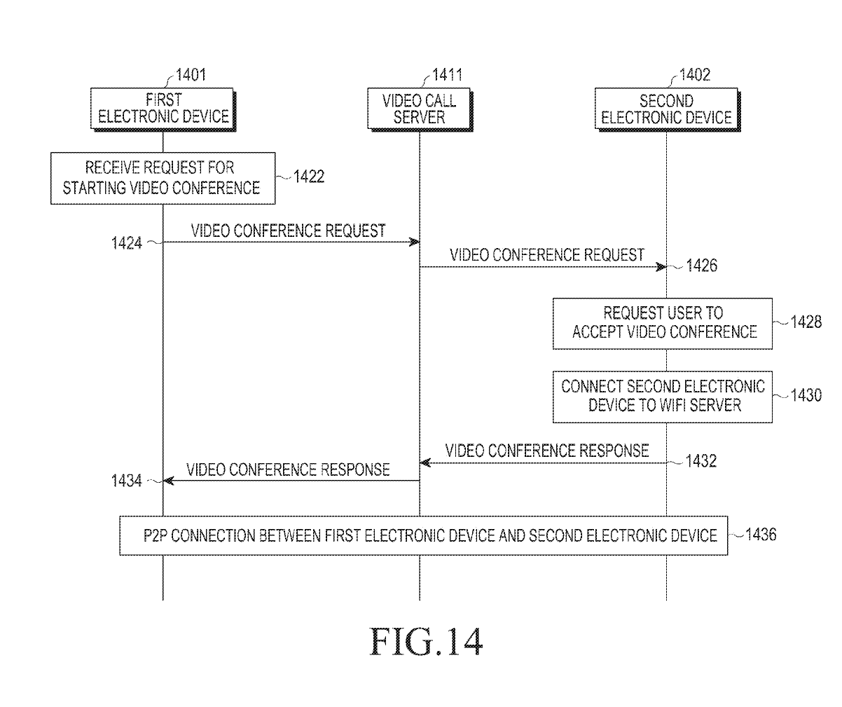

FIG. 14 is a flow diagram of a method in which electronic devices establish a video call, according to an embodiment of the present disclosure.

In FIG. 14, it is assumed that the first electronic device 1401 and the second electronic device 1402 execute a video call.

Referring to FIG. 14, the first electronic device 1401 receives a request for initiating a video call service (e.g., a video conference) from a user of the first electronic device 1401 in step 1422. In step 1424, the first electronic device 1401 requests a video call server 1411 to provide the video call service, for example, a video conference.

In step 1426, the video call server 1411 requests, from the second electronic device 1402, a video conference with the first electronic device 1401. In step 1428, the second electronic device 1402 requests a user of the second electronic device 1402 to accept the video conference with the first electronic device 1401 or a user of the first electronic device 1401. When the second electronic device 1402 or the user of the second electronic device 1402 accepts the video conference, the second electronic device 1402 connects the second electronic device 1402 to a WiFi server in step 1430.

According to an embodiment of the present disclosure, the second electronic device 1402 transmits, to the video call server 1411, a video conference response corresponding to the video conference request of step 1426, in step 1432. The video conference response of step 1432 may be a message indicating that the second electronic device 1402 accepts the video conference with the first electronic device 1401.

In step 1434, the video call server 1411 transmits, to the first electronic device 1401, the video conference response corresponding to the video conference request of step 1422. The video conference response of step 1434 may be a message indicating that the second electronic device 1402 accepts the video conference with the first electronic device 1401, and a setting for proceeding with the video conference is completed.

As described above, when both the first electronic device 1401 and the second electronic device 1402 are establishing a video conference, a P2P connection between the first electronic device 1401 and the second electronic device 1402 may be set in step 1436. Through the P2P connection, the first electronic device 1401 and the second electronic device 1402 may proceed with the video conference.

A method for providing a video call by an electronic device according to an embodiment of the present disclosure includes receiving, from a second external electronic device, a request message for a video call between the electronic device and a first external electronic device, through a first communication module, selecting a first communication scheme to be used for a communication connection for the video call from among the plurality of communication schemes, identifying connection information allocated to the electronic device by a third external electronic device connected to the electronic device in communication, using the first communication scheme, and transmitting, to the second external electronic device, a response message in response to the request message such that at least part of the connection information is used for establishing the communication connection.

According to an embodiment of the present disclosure, the plurality of communication schemes include a WiFi communication scheme, and the second external electronic device is a base station or an access point, which supports the WiFi communication scheme.

According to an embodiment of the present disclosure, in the method for providing a video call by an electronic device, the plurality of communication schemes include a cellular-based communication scheme, and an operation of recognizing a base station or an access point, which supports the cellular-based communication scheme, as the second external electronic device.

According to an embodiment of the present disclosure, the method for providing a video call by an electronic device may further include, during or after the communication connection for the video call is established based on at least a part of the connection information, if a second wireless communication scheme is available from among the plurality of communication schemes, excluding the first wireless communication scheme, transmitting, to the second external device, another request for establishing the communication connection, using the second wireless communication scheme.

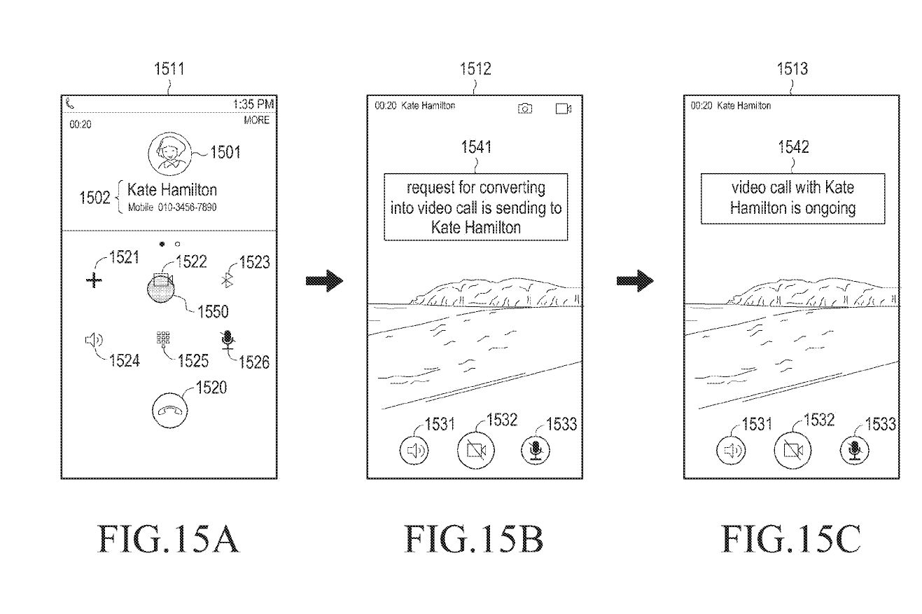

FIGS. 15A, 15B, and 15C are execution screens illustrating a method in which an electronic device converts a voice call into a video call, according to an embodiment of the present disclosure.

FIGS. 15A, 15B, and 15C illustrate execution screens of an application (e.g., an SWIS application and the like) for providing a video call service.

The processor 120 of the first electronic device 101 may execute an application associated with a voice call or a video call. When the application associated with the voice call or video call is executed, the display 160 may display an execution screen 1511, 1512, and 1513 as illustrated in FIGS. 15A to 15C, respectively.

Referring to FIG. 15A, during a voice call, the execution screen 1511 may include objects 1521, 1522, 1523, 1524, 1525, and 1526 associated with a voice call function, information associated with a user of the second electronic device 104 that executes a voice call with the first electronic device 101, for example, an image 1501, a name, and a phone number 1502. The first object 1521 is an icon for selecting or adding a partner for a voice call. The second object 1522 is an icon for converting a voice call into a video call. The third object 1523 is an icon for a connection using Bluetooth. The fourth object 1524 is an icon for converting the audio output into a speaker phone. The fifth object 1525 is an icon for displaying a keypad in the display 160. The sixth object 1526 is an icon for executing a mute operation. An object 1520 for indicating that a voice call is ongoing may be included in the execution screen 1511.

In the state in which the execution screen 1511 of FIG. 15A is displayed in the display 160, when a user input 1550 for selecting the second object 1522 is input (that is, a user input for switching a voice call into a video call is input), the display 160 of the first electronic device 101 may display, for example, the execution screen 1512 of FIG. 15B. FIG. 15B illustrates the execution screen 1512 indicating that a request for converting the voice call into a video call is sent to an electronic device (e.g., the second electronic device 104) of a partner (Kate Hamilton) who is on the voice call.

Referring to FIG. 15B, when the request for converting the voice call into a video call is sent to the partner electronic device, for example, the second electronic device 104, the display 160 of the first electronic device 101 may display an image input through a camera module (e.g., the camera module 291) in real time. Also, the execution screen 1512 may include objects 1531, 1532, and 1533 associated with a video call function, and a notification 1541 indicating that conversion to a video call is in progress. In FIG. 15B, the display 160 displays the execution screen 1512 including the notification 1541, “A request for converting into a video call is sending to Kate Hamilton”, so that the first electronic device 101 informs a user of the first electronic device 101 that conversion into a video call is in progress.

FIG. 15C is the execution screen 1513 displayed in the display 160 when a video call with a partner electronic device, for example, the second electronic device 104, is ongoing. Referring to FIG. 15C, the display 160 of the first electronic device 101 may display an image input through a camera module 291 in real time. Also, the execution screen 1513 may include the objects 1531, 1532, and 1533 associated with a video call function, and a notification 1542 indicating that a video call is ongoing. In FIG. 15C, the display 160 displays the execution screen 1513 including the notification 1542, “A video call with Kate Hamilton is ongoing”, so that the first electronic device 101 informs a user of the first electronic device 101 that a video call with the second electronic device 104 is ongoing.

A non-transitory storage medium storing instructions according to an embodiment of the present disclosure is provided, wherein the instructions when executed by at least one processor cause the processor to execute a method including receiving, from a second external electronic device, a request message for a video call between the electronic device and a first external electronic device, through a first communication module, selecting a first communication scheme to be used for a communication connection for the video call from among the plurality of communication schemes, identifying connection information allocated to the electronic device by a third external electronic device connected to the electronic device in communication, using the first communication scheme, and transmitting, to the second external electronic device, a response message in response to the request message such that at least part of the connection information is used for establishing the communication connection.

The term “module” as used herein may, for example, mean a unit including one of hardware, software, and firmware or a combination of two or more of them. The term “module” may be interchangeably used with, for example, the terms “unit”, “logic”, “logical block”, “component”, or “circuit”. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations which are known or are to be developed hereinafter.

According to an embodiment of the present disclosure, at least some of the devices (for example, modules or functions thereof) or the method (for example, operations) according to the present disclosure may be implemented by a command stored in a non-transitory computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a read only memory (ROM), a random access memory (RAM), a flash memory), and the like. In addition, the program instructions may include high level language codes, which may be executed in a computer by using an interpreter, as well as machine codes made by a compiler. The aforementioned hardware device may be configured to operate as one or more software modules in order to perform the operation of the present disclosure, and vice versa.

The programming module according to an embodiment of the present disclosure may include one or more of the aforementioned components or may further include other additional components, or some of the aforementioned components may be omitted. Operations executed by a module, a programming module, or other component elements may be executed sequentially, in parallel, repeatedly, or in a heuristic manner. Furthermore, some operations may be executed in a different order or may be omitted, or other operations may be added.

Various embodiments disclosed herein are provided to describe technical details of the present disclosure and to help in the understanding of the present disclosure, but do not limit the scope of the present disclosure. Accordingly, the scope of the present disclosure should be construed as including all modifications or various embodiments based on the technical idea of the present disclosure as defined by the appended claims and their equivalents.

What is claimed is:

1. An electronic device, comprising:
a communication interface configured to support a plurality of communication schemes; and
a processor configured to:
receive, through the communication interface, a request message for a video call between the electronic device and a first external electronic device from a second external electronic device,
select a first wireless communication scheme to be used for a communication connection for the video call from among the plurality of communication schemes,
identify connection information allocated to the electronic device by a third external electronic device connected to the electronic device, using the first wireless communication scheme, and
control the communication interface to transmit, to the second external electronic device, a response message in response to the request message such that at least part of the connection information is used for establishing the communication connection.

2. The electronic device of claim 1, wherein the plurality of communication schemes includes a wireless fidelity (WiFi) communication scheme, and
wherein the processor is further configured to recognize a base station or an access point, which supports the WiFi communication scheme, as the third external electronic device.

3. The electronic device of claim 1, wherein the plurality of communication schemes includes a cellular communication scheme, and
wherein the processor is further configured to recognize a base station or an access point, which supports the cellular communication scheme, as the third external electronic device.

4. The electronic device of claim 1, wherein the processor is further configured to:
during or after the communication connection for the video call is established based on the connection information, if a second wireless communication scheme is available from among the plurality of communication schemes, control the communication interface to transmit another request for establishing the communication connection to the third external electronic device using the second wireless communication scheme.

5. The electronic device of claim 4, wherein the processor is further configured to:
control the communication interface to interrupt the communication connection using the first wireless communication scheme.

6. The electronic device of claim 1, wherein the processor is further configured to:
while a voice call is connected between the electronic device and the first external electronic device, control the communication interface to receive the request message, using a second wireless communication scheme from among the plurality of communication schemes.

7. The electronic device of claim 6, wherein the first wireless communication scheme includes a Wi-Fi communication scheme;
the second wireless communication scheme includes a cellular communication scheme;
the communication interface includes a first communication module for supporting the Wi-Fi communication scheme and a second communication module for supporting the cellular communication scheme; and
the processor is further configured to:
determine the connection information using the first communication module, and
connect the voice call using the second communication module.

8. The electronic device of claim 1, wherein the processor is further configured to:
determine a type of electronic device of the third external electronic device; and
if the third external electronic device includes an access point of a provider that provides at least one communication service, obtain another connection information allocated to the electronic device by a fourth external electronic device that is connected to the electronic device, using the first communication scheme.

9. The electronic device of claim 1, wherein the processor is further configured to:
display an object associated with execution of the video call, in response to receiving the request message.

10. The electronic device of claim 9, wherein the processor is further configured to control the communication interface to transmit the response message to the first external electronic device, based on a user input for selecting the object.

11. The electronic device of claim 9, wherein the processor is further configured to display the object after the communication connection for the video call is established.

12. A method for providing a video call by an electronic device, the method comprising:
receiving, from a second external electronic device, a request message for a video call between the electronic device and a first external electronic device, through a first communication module;
selecting a first communication scheme to be used for a communication connection for the video call from among a plurality of communication schemes;
identifying connection information allocated to the electronic device by a third external electronic device, using the first communication scheme; and
transmitting, to the second external electronic device, a response message in response to the request message such that at least part of the connection information is used for establishing the communication connection.

13. The method of claim 12, wherein the plurality of communication schemes includes a wireless fidelity (WiFi) communication scheme, and
wherein the second external electronic device is a base station or an access point, which supports the WiFi communication scheme.

14. The method of claim 12, further comprising:
during or after the communication connection for the video call is established based on the at least a part of the connection information, if a second wireless communication scheme is available from among the plurality of communication schemes, transmitting, to the second external electronic device, another request for establishing the communication connection, using the second wireless communication scheme.

15. An electronic device, comprising:
at least one communication interface configured to support a plurality of communication schemes; and
a processor configured to:
transmit, through the at least one communication interface, a request message for a second communication connection for a video call with a first external electronic device to a second external electronic device, while a first communication connection for a voice call between the electronic device and the first external electronic device is established using a first wireless communication scheme through the at least one communication interface, and
if a response message, in response to the request message, is received from the second external electronic device, control the at least one communication interface to establish the second communication connection based on the response message.

16. The electronic device of claim 15, wherein the processor is further configured to:
establish the second communication connection while the first communication connection is maintained.

17. The electronic device of claim 15, wherein the first wireless communication scheme includes a circuit switching communication scheme; and
wherein the processor is further configured to recognize a base station or an access point, which supports the circuit switching communication scheme, as a third external electronic device for the first communication connection with the first external electronic device.

18. The electronic device of claim 17, wherein the plurality of communication schemes includes a packet switching communication scheme; and
wherein the processor is further configured to recognize a base station or an access point, which supports the packet switching communication scheme, as the second external electronic device.

19. The electronic device of claim 15, wherein the first wireless communication scheme includes a cellular communication scheme; and
wherein the processor is further configured to recognize a base station or an access point, which supports the cellular communication scheme, as a third external electronic device for the first communication connection with the first external electronic device.

20. The electronic device of claim 19, wherein the plurality of communication schemes includes a WiFi communication scheme, and
wherein the processor is further configured to recognize a base station or an access point, which supports the WiFi communication scheme, as the second external electronic device.
